(19) United States
(12) Patent Application Publication
(10) Pub. No.: US 2020/0159375 A1
(43) Pub. Date: May 21, 2020

(54) GRAPHICAL INTERFACE DISPLAYS AT PROGRAM LOCATIONS

(71) Applicant: GOOGLE LLC, Mountain View, CA (US)

(72) Inventor: Niket Desai, San Francisco, CA (US)

(21) Appl. No.: 16/244,073

(22) Filed: Jan. 9, 2019

Related U.S. Application Data
(63) Continuation of application No. 13/941,415, filed on Jul. 12, 2013, now abandoned.
(60) Provisional application No. 61/794,841, filed on Mar. 15, 2013.

(51) Int. Cl. G06F 3/0484; G06Q 30/06

(52) U.S. Cl. CPC G06F 3/0484; G06Q 30/0639

(57) ABSTRACT

A system and computer-implemented method are provided for facilitating a graphical user interface display on a computing device at a location of a service system, including identifying a user device associated with a user located within a predetermined distance of a location associated with a service system, retrieving information regarding the user including one or more of user characteristics or user activity information, providing the information for display to the computing device at the location of the service system via a graphical user interface while the user device is located within the predetermined distance of the location associated with the service system, determining one or more actions corresponding to actions to be taken by the service system towards the user and providing the one or more actions for display via the graphical user interface of the computing device at the location of the service system along with the information.

### BACKGROUND

With the digitalization of service programs, service systems have built an electronic connection with users. Such connection provides the service system with a wealth of information regarding users, including information available regarding users across various online services. This information is typically available regarding users who have visited a location and performed an action at the location. The information, while available, is not typically categorized for provision to the service system in an actionable manner. Providing service systems with real-time information regarding potential users at locations, along with recommendations for actions to be taken with regard to the users according to the information would provide additional benefits for service systems.

### SUMMARY

The disclosed subject matter relates to a computer-implemented method for providing a graphical user interface display at a service system location, the method comprising by one or more computing devices, receiving location information of a user computing device associated with a user; determining, based on the received location information of the user computing device, that a location of the user computing device is within a specified distance of a location associated with a service system; in response to determining that the location of the user computing device is within the specified distance of the location associated with the service system, retrieving user information regarding the user associated with the user computing device that is within the specified distance of the location associated with the service system, the user information comprising one or more of user characteristics and user activity information; determining one or more actions based on the user information, the each of the one or more actions corresponding to actions to be taken by the service system towards the user; providing instructions to a computing device associated with the service system at the location of the business to render, via a graphical user interface, a presentation of all or part of the user information while the user computing device is located within the specified distance of the location associated with the service system, the presentation including a control for displaying by the computing device associated with the service system and corresponding to a particular action of the one or more determined actions together with the user information, selection of the control initiating the particular action towards the user associated with the user computing device that is within the specified distance of the location associated with the service system; receiving, from the computing device associated with the service system, an input indicating a selection of the control corresponding to the particular action; and in response to receiving the input indicating the selection of the control, providing instructions to the computing device associated with the service system to update the graphical user interface to render, via the updated graphical user interface, a display of information associated with the particular action.

The disclosed subject matter also relates to a system for providing a graphical user interface display at a service system location, the system comprising one or more processors and a machine-readable medium comprising instructions stored therein, which when executed by the processors, cause the processors to perform operations comprising determining that one or more user devices, associated with one or more users are located within the predetermined distance of a geographic location of a service system. The operations may further comprise determining information regarding the one or more users, the information comprising individual information regarding the one or more users or aggregate information regarding two or more of the one or more users. The operations may further comprise determining one or more actions based on the information to be taken by the service system towards at least one of the one or more users or a group of users of the one or more users and providing the one or more actions for display to the service system via a graphical user interface display on a computing device at the service system location while the one or more user devices are located within the predetermined distance of the geographic location of the service system.

The disclosed subject matter also relates to a machine-readable medium comprising instructions stored therein, which when executed by a machine, cause the machine to perform operations comprising identifying one or more users associated with one or more user devices located within a predetermined distance of the location associated with a service system. The operations may further comprise retrieving information regarding the one or more users, the information including profile information regarding the user as well as user activity information relating to the service system. The operations may further comprise determining one or more goals associated with the service system. The operations may further comprise identifying a plurality of actions for achieving at least one of the one or more goals. The operations may further comprise determining the one or more actions from the plurality of actions, wherein the one or more actions are determined based on the information and providing the one or more actions for display to the service system via a graphical user interface of a computing device at the location associated with the service system while the one or more user devices are located within the predetermined distance of the location associated with the service system.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for providing service systems with real-time information and recommended actions regarding current users.

FIG. 2 illustrates a flow diagram of an example process for providing service systems with real-time information and recommended actions regarding current users.

FIGS. 3-6 illustrate example graphical user interfaces provided for display to service system computing devices to facilitate providing merchants with real-time information and recommended actions regarding current users.

FIG. 7 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

### I. Overview

The subject disclosure provides a method and system for providing merchants with real-time information regarding in-store or proximate potential customers, along with recommendations for actions to be taken with regard to the customers according to the information. Information regarding customers may be provided for display to the merchant (e.g., on a private display). Additionally, recommended actions for creating a better in-store experience for the customers may be determined by the system based on information regarding the user and provided for display to the merchant, for example, along with the information.

Customers proximate to or within a place of business are identified using various methods, including, for example, one or more of geographic location (e.g., GPS tracking where the customer has opted in to have their location known), check-ins, transactions through a credit card linked to a user profile, user logins to various loyalty programs, or other services that provide information regarding the proximity or presence of the user at a store location. In various implementations, in order for a user to obtain the benefits described herein, the user may have to install an application (e.g., on a mobile phone) and/or select options on a website. In doing so, the user will enable the store to use location and other user data to provide better offers and other content. In some embodiments, if the user does not install the appropriate application and/or make the appropriate settings changes, the merchant may not be able to view the information for that customer and/or use information for that customer to provide focused offers or other content.

Once a customer is identified as being proximate to the merchant's place of business, the customer is identified as a “current customer.” As used herein, the term “current customer,” encompasses its plain and ordinary meaning, including, but not limited to, a customer that is proximate to a place of business associated with a merchant. Proximity to a place of business may be determined based on various criteria, including for example, whether a user is located within a defined distance from a location of the business or within a defined region encompassing the location of a business. Current customers are likely to be a great audience for actions that can be performed by a merchant to achieve specific goals. The term “customer,” as used herein, encompasses its plain and ordinary meaning, including, but not limited to, any person and may include, but is not limited to, persons having previously visited the store, indicated interest in the merchant or products or services provided by the merchant, or otherwise being identified as a potential customer and/or consumer. The term “merchant,” as used herein, encompasses its plain and ordinary meaning, including, but not limited to, any individual having interest in marketing to potential customers and/or consumers regard one or more products, services and/or offers.

In one example, information regarding one or more current customers (e.g., those customer participating in the techniques described herein) is retrieved from various sources including loyalty programs, shopping programs, check-in services, social networking services and other online and/or offline (e.g., in store) services, maintaining information regarding a user. The information may include demographic information, shopping preferences, purchasing activities and behavior, desired products, shopping goals and/or other similar customer information that may be useful to the business. In one example the information may include overall information regarding various businesses and/or information specific to the merchant's business. In some examples, the information may include individual information about customers proximate to the merchant's place of business and/or various aggregate information regarding current customers (in-store or proximate to the store) or past customers. Current customers may be grouped based on various criteria, including proximity to a store, last time visited, aggregate expenditures at store, level of progress in loyalty programs, social influence, likelihood to response, and demographics. As discussed above, in order to obtain the benefits of the techniques described herein, the user may have to install an application and/or select an option on a website.

The information regarding current customers may be provided for display to the merchant in real-time as current customers are identified. In some implementations, one or more actions may be determined based on information regarding one or more current customers identified as being proximate to the merchant's place of business and/or one or more information regarding the merchant including, for example, one or more goals and/or objectives of the merchant. The one or more actions may be determined based on customer information for one or more individual customers or for a number of the customers in aggregate. The determined actions may be provided for display to the merchant (e.g., as recommendations) in real-time while the current customers are proximate to the merchant's place of business, and/or may be automatically performed in real-time.

In one example, the merchant may provide various information regarding goals and objectives the merchant wishes to achieve with regards to customers. According to the information regarding the current customers at any time, particular actions may be determined for the merchant to reach those goals and/or to improve overall user experience and may be provided to the merchant in real-time (e.g., while the current customers are proximate to the merchant's place of business), and/or automatically performed. In one example, various actions may be recommended and/or performed with regard to individual current customers, all current customers or groups of current customers.

Upon identifying current customer, in some implements, the system may also generate and provide a communication channel between the merchant and current customers, to provide real-time communication through various channels such as online services including loyalty programs, coupon services, social networking services, mobile services, text messages or voice calls, or in person interaction, to promote the business or products and offer personalized promotions and services to the customer. In one example, communication channels may be created for communicating with individual current customers, all current customers in aggregate or specific groups of current customers.

### II. Example Client-Server Network Environments for Facilitating Real-Time Information and Recommended Actions Regarding Current Customers

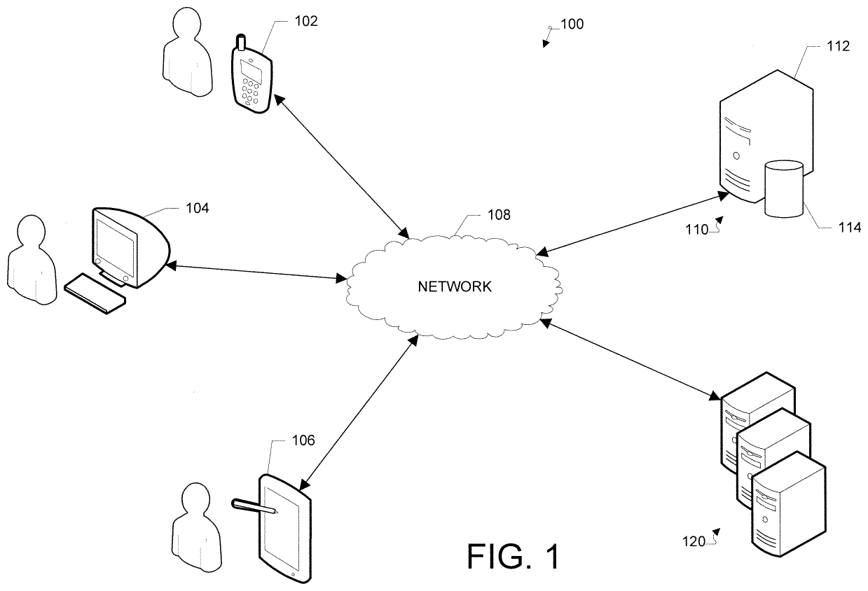

FIG. 1 illustrates an example client-server network environment which provides for providing merchants with real-time information and recommended actions regarding current customers. A network environment 100 includes a number of electronic devices 102, 104 and 106 communicably connected to a server 110 by a network 108. One or more remote servers 120 are further coupled to the server 110 and/or the one or more electronic devices 102, 104 and 106. Server 110 includes a processing device 112 and a data store 114. Processing device 112 executes computer instructions stored in data store 114, for example, to assist in providing merchants interacting with at electronic devices 102, 104 or 106 with real-time information and recommended actions regarding current customers interacting with at electronic devices 102, 104 and/or 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In one example, the electronic devices 102, 104 and 106 store a User agent such as a browser or application. In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108. In one example, the server 110 may host a system for providing merchants with real-time information and recommended actions regarding current customers.

Each of the one or more remote servers 120 can be a single computing device such as a computer server or can represent more than one computing device working together to perform the actions of a server computer (e.g., cloud computing). Each of the one or more remote servers 120 may host one or more remote services maintaining, and/or data stores storing, information regarding one or more customers and/or merchants. In one example, one or more remote servers 120 may host one or more social networking services, maintaining information regarding a user, and/or one or more contacts of the user, which the user is associated with at the one or more social networking services. In one embodiment server 110 and one or more remote servers 120 may be implemented as a single server hosting the system and one or more data stores and remote services. In one example, the server 110 and one or more remote servers 120 may communicate through the user agent at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

### III. Example Processes for Facilitating Real-Time Information and Recommended Actions Regarding Current Customers

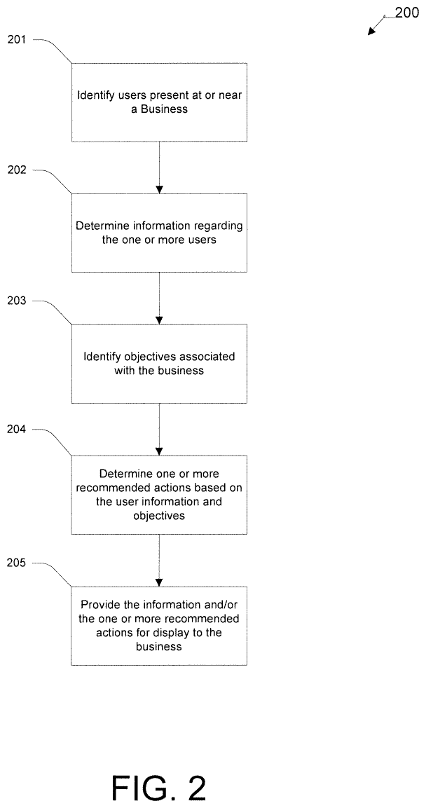

FIG. 2 illustrates a flow diagram of an example process 200 for providing merchants with real-time information and recommended actions regarding current customers.

In block 201, one or more users (current customers) present within a predetermined distance of a business are identified. The location of users (e.g., those utilizing the techniques described herein) may be determined using various methods, including, for example, one or more of geographic location indicators (e.g., GPS tracking where the customer has opted in to have their location known), check-ins, transactions through a credit card linked to a user profile, user logins to various loyalty programs, or other services that provide information regarding the proximity or presence of the user at a store location. In various implementations, in order for a user to obtain the benefits described herein, the user may have to install an application (e.g., on a mobile phone) and/or select options on a website. In doing so, the user will enable the store to use location and other user data to provide better offers and other content. In some embodiments, if the user does not install the appropriate application and/or make the appropriate settings changes, the merchant may not be able to view the information for that customer and/or use information for that customer to provide focused offers or other content. Each business may provide information regarding the location of the business, for example, using longitude latitude, address or other location indictors. In one example, the location of a business may be determined based on information including customer check-ins, searches for the business, location of nearby businesses, and/or other similar information providing an indication of where the business is located. The location of users may then be compared to the location of the business, to determine if the user is in proximity to the business. In one example, a predefined threshold distance or region may be defined for each business based on the location of the business. A user may be determined to be proximate to the business when the user is at a location that meets the threshold, and/or is within the region.

Once a user is identified as being proximate to the business (e.g., merchant's place of business), the user is identified as a “current customer”.

In block 202, information regarding the one or more users (current customers), identified in block 201, is determined. In one example, information regarding one or more current customers is retrieved from various sources including loyalty programs, shopping programs, check-in services, social networking services and other online and/or offline (e.g., in store) services, maintaining information regarding a user. The information may include demographic information, shopping preferences, purchasing activities and behavior, desired products, shopping goals and/or other similar customer information that may be useful to the business.

In various implementations, in order for a user to obtain the benefits described herein, the user may have to install an application (e.g., on a mobile phone) and/or select options on a website. In doing so, the user will enable the store to use location and other user data to provide better offers and other content. In some embodiments, if the user does not install the appropriate application and/or make the appropriate settings changes, the merchant may not be able to view the information for that customer and/or use information for that customer to provide focused offers or other content.

The information may include overall information regarding various businesses and/or information specific to the merchant's business. In some examples, the information may include individual information about individual users proximate to the merchant's place of business and/or aggregate information regarding a group of the users, and/or historical information regarding past customers (e.g., customers similar to the users). Users (e.g., users generally and/or users identified as current customers) may be grouped based on various criteria, including proximity to store, last time visited, aggregate expenditures at store, level of progress in loyalty programs, social influence, likelihood to response, and demographics. Information may then be provided according to the grouping of the users.

In block 203, one or more objectives associated with the business are identified. In one example, the merchant may provide various information regarding goals and objectives the merchant wishes to achieve with regards to customers. Goals of the business may be long term or short term goals and/or objectives with respect to individual or specific users, groups of users, or may be an overall goal or objective. Goals may include purchases, increasing exposure, introducing new products or services, marketing existing products or services, building customer loyalty, and other similar marketing and business related goals.

In block 204, the system determines one or more recommended actions for the business. In some implementations, the one or more recommended actions may be determined based on the information determined in block 202 and/or information regarding the merchant including, for example, the one or more goals identified in block 203. In one example, according to the information regarding the current customers, particular actions may be determined that help the business meet the goals identified in block 202, and/or to improve overall user experience. The one or more actions may for example be selected based on historical information showing a correlation between the action and the desired goal or objective (e.g., for user with certain characteristics). In one example, one or more correlations may be defined between one or more actions and one or more goals. In one example, the one or more correlations may further be defined based on specific user characteristics.

In block 205, the information regarding the one or more users (current customers) determined in block 202 and/or one or more of the recommended actions determined in block 204 may be provided for display to the business in real-time while the current customers are proximate to the merchant's place of business. In one example, one or more of the recommended actions may be automatically performed in real-time (e.g., based on business preferences or settings). Example actions may include sending offers or advertisements to one or more of the users and/or encouraging reviews, feedback and/or social activity (e.g., checking in) from the users.

Upon identifying current customers, in some implementations, the system may also generate and provide a communication channel between the merchant and current customers, to provide real-time communication through various channels such as online services including loyalty programs, coupon services, social networking services, mobile services, text messages or voice calls, or in person interaction, to promote the business or products and offer personalized promotions and services to the customer. In one example, communication channels may be created for communicating with individual current customers, all current customers in aggregate or specific groups of current customers.

### IV. Example Graphical User Interfaces for Providing Real-Time Information and Recommended Actions Regarding Current Customers for Display

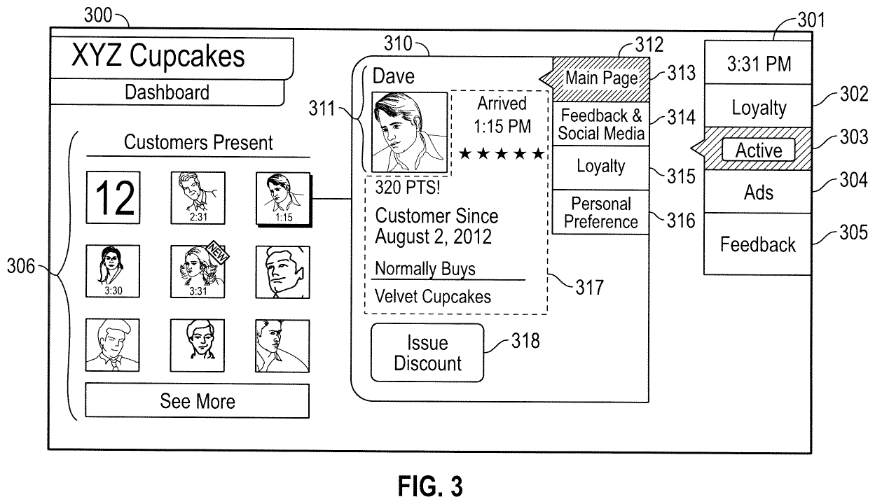

FIGS. 3-6 illustrate example graphical user interfaces provided for display to a merchant to facilitate providing the merchant with real-time information and recommended actions regarding current customers.

FIG. 3 depicts a “dashboard” 300 providing information and/or recommended actions relating to customers currently within a predetermined distance of the merchant for display to the merchant (e.g., “XYZ Cupcakes”). In one example, as shown in FIG. 3, dashboard 300 may include a menu area 301. Menu 301 provides selections including a “loyalty” tab 302, “active” tab 303, “ads” tab 304 and “feedback” tab 305. In one example, loyalty tab 302 may be selected to view loyalty information regarding the merchant, including information regarding current customers and/or historical information regarding all or some customers of the merchant. Active tab 303, shown as being selected in FIG. 3, provides various information regarding current customers for display to the merchant. Ads tab 304 may provide information regarding various advertisement and promotional materials of the merchant, and/or analytics regarding the ads and/or promotional materials. The feedback tab 305 may be selected to provide information regarding customer feedback regarding the merchant including feedback information for one or more current and/or past customers of the merchant.

As shown, the active tab 303 is selected in the dashboard 300. The dashboard 300 displays a “customers present” list 306, including one or more customers within a predetermined distance of the merchant's place of business. In one example, the merchant may select one of the displayed one or more customers to view customer specific information regarding that customer.

In FIG. 3, a customer “Dave S” is shown as being selected. In one example, in response to the selection, a window 310 is displayed. The customer window 310 includes a customer name and photo 311 and a menu 312 with selections including, a “main page” tab, 313, a “feedback and social media” tab 314, a “loyalty” tab 315, and a “personal preference” tab 316. In FIG. 3, main page tab 313 is shown as being selected, and provides general information regarding the customer for display in area 317. In one example, the main page tab may also provide one or more recommended actions for display, including, for example, the “issue discount” button 318, shown in window 310 of FIG. 3.

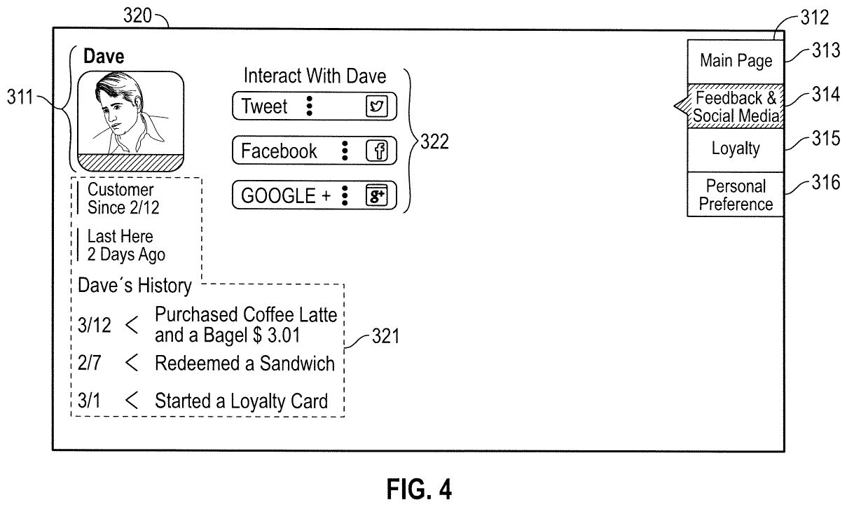

The feedback and social media tab 314 may be selected to provide information regarding the social media and feedback activity of the user relating to the merchant and/or one or more other merchants, as well as historical activity of the user, for display. FIG. 4 illustrates an example of the information provided for display within a window 320 when the feedback and social media tab 314 is selected. Similar to window 310 of FIG. 3, window 320 displays the name and photo 311 of the customer and the menu 312. Additionally, as shown in FIG. 4, one or more information regarding the activity of the user is displayed in area 321. Furthermore, a social networking area 322 provides one or more communication recommendations to interact with the customer.

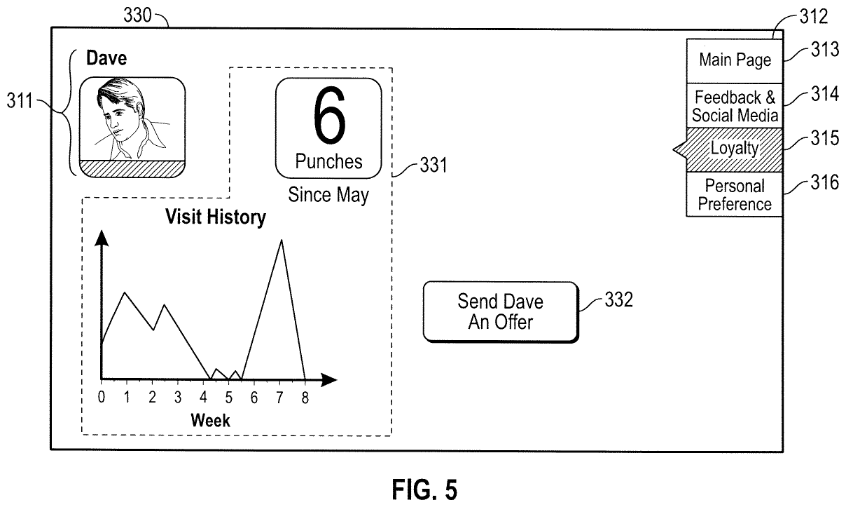

The loyalty tab 315 may provide information regarding the visit and purchase history of the customer for display. FIG. 5 depicts an example of the information provided for display within a customer window 330 when the loyalty tab is selected. Similar to customer window 310 of FIG. 3, window 330 displays the name and photo 311 of the customer and the menu 312. Additionally, the visiting history of the customer and/or the number of visits and/or purchases (e.g., “punches”) of the customer is displayed in an area 331. In one example, the customer window 330, displayed in response to selecting the loyalty tab 315, may also provide one or more recommended actions for display, including, for example, the “Send Dave an Offer” button 332.

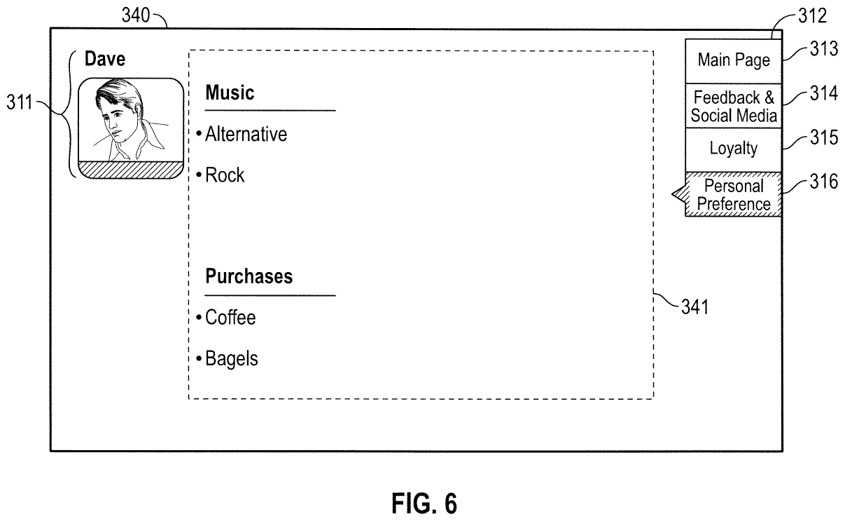

The personal preference tab 316 may provide information regarding customer preferences for display. FIG. 6 depicts an example of the information provided for display within a customer window 340 when the personal preference tab 316 is selected. Similar to customer window 310 of FIG. 3, customer window 340 displays the name and photo 311 of the customer and the menu 312. Additionally, information regarding user preferences such as music and purchasing preferences of the user may be provided for display within display area 341.

### V. Example Systems for Facilitating Real-Time Information and Recommended Actions Regarding Current Customers

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

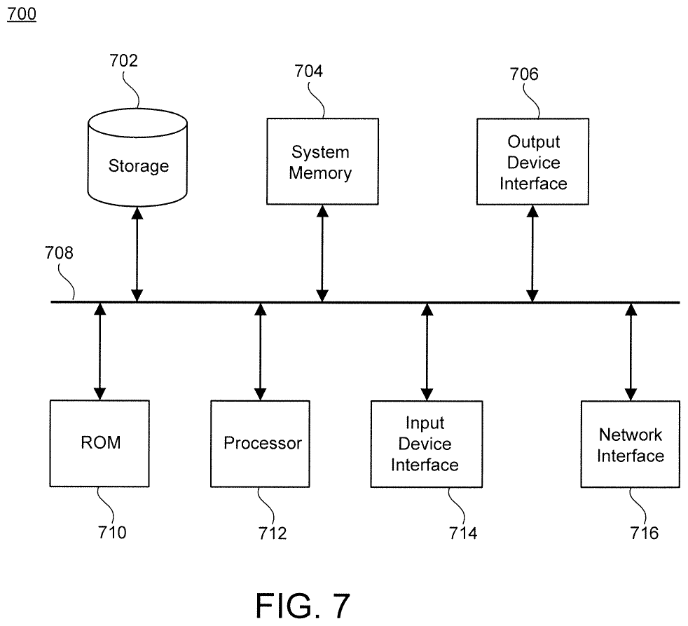

FIG. 7 conceptually illustrates an electronic system with which some implementations of the subject technology are implemented. Electronic system 700 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for providing merchants with real-time information and recommended actions regarding current customers according to various embodiments. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of exemplary approaches. Based upon design preferences, it is understood that the specific order or hierarchy of blocks in the processes may be rearranged, or that some illustrated blocks may not be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method to render graphical user interfaces to provide customized controls associated with specified actions for particular users, comprising:
by one or more computing devices:
receiving location information of a user computing device associated with a user;
determining, based on the received location information, that a location of the user computing device is within a specified distance of a location associated with a service system;
in response to determining that the location of the user computing device is within the specified distance of the location associated with the service system, retrieving user information regarding the user associated with the user computing device that is within the specified distance of the location associated with the service system, the user information comprising one or more of user characteristics and user activity information;
determining one or more goals associated with the service system;
identifying a plurality of actions based on a historical correlation between the plurality of actions and the one or more goals;
determining one or more recommended actions from the plurality of actions based on the user information and the one or more goals, the each of the one or more recommended actions corresponding to actions to be taken by the service system towards the user;
providing instructions to a computing device associated with the service system at the location of the service system to render, via a graphical user interface, a presentation of all or part of the user information while the user computing device is located within the specified distance of the location associated with the service system, the presentation comprising a control for displaying by the computing device associated with the service system and corresponding to a particular action of the one or more recommended actions together with the user information, selection of the control initiating the particular action towards the user associated with the user computing device that is within the specified distance of the location associated with the service system;
receiving, from the computing device associated with the service system, an input indicating a selection of the control corresponding to the particular action; and
in response to receiving the input indicating the selection of the control, providing instructions to the computing device associated with the service system to update the graphical user interface to render, via the updated graphical user interface, a display of information associated with the particular action.

2. The method of claim 1, wherein the location information comprises global positioning system (“GPS”) information of the user computing device.

3. The method of claim 1, wherein the location information comprises data indicating a check-in of the user to the location associated with the service system or to a location within a threshold distance from the location associated with the service system.

4. The method of claim 1, wherein the user information comprises information regarding the past activity of the user with respect to the service system.

5. The method of claim 1, wherein the user information comprises information regarding the past activity of the user with respect to one or more other service systems similar to the service system.

6. The method of claim 1, wherein determining the one or more actions further comprises, by the one or more computing devices:
identifying a plurality of actions for achieving at least one of the one or more goals; and
determining the one or more recommended actions from the plurality of actions, wherein the one or more actions are determined based on the user information.

7. The method of claim 6, further comprising providing, by the one or more computing devices, the service system with means for performing one or more of the recommended actions, wherein the one or more recommended actions are performed by communicating with the user at the user computing device using the user information.

8. The method of claim 1, wherein the user information further comprises contact information for the user.

9. The method of claim 1, wherein the user information further comprises demographic information regarding the user.

10. The method of claim 1, further comprising, by the one or more computing devices:
receiving a request to select a group of users based on one or more criteria, the one or more users being associated with one or more other user computing devices located within the specified distance of the location associated with the service system;
identifying one or more users including the user; and
determining one or more of the one or more users meeting the one or more criteria.

11. The method of claim 10, wherein the request comprises performing an action with respect to the group, the method further comprising performing, by the one or more computing devices, the action with respect to the one or more of the one or more users.

12. A system to provide in-store graphical user interfaces comprising customized controls associated with specified actions for particular users, comprising:
one or more processors; and
a machine-readable medium comprising instructions stored therein, which when executed by the processors, cause the processors to perform operations comprising:
receiving location information of a user computing device associated with a user;
determining, based on the received location information of the user computing device, that a location of the user computing device is within a specified distance of a location associated with a service system;
in response to determining that the location of the user computing device is within the specified distance of the location associated with the service system, retrieving user information regarding the user associated with the user computing device that is within the specified distance of the location associated with the service system, the user information comprising one or more of user characteristics and user activity information;
determining one or more goals associated with the service system;
identifying a plurality of actions based on a historical correlation between the plurality of actions and the one or more goals;
determining one or more recommended actions from the plurality of actions based on the user information and the one or more goals, the each of the one or more recommended actions corresponding to actions to be taken by the service system towards the user;
providing instructions to a computing device associated with the service system at the location of the service system to render, via a graphical user interface, a presentation of all or part of the user information while the user computing device is located within the specified distance of the location associated with the service system, the presentation including a control for displaying by the computing device associated with the service system and corresponding to a particular action of the one or more recommended actions together with the user information, selection of the control initiating the particular action towards the user associated with the user computing device that is within the specified distance of the location associated with the service system;
receiving, from the computing device associated with the service system, an input indicating a selection of the control corresponding to the particular action; and
in response to receiving the input indicating the selection of the control, providing instructions to the computing device associated with the service system to update the graphical user interface to render, via the updated graphical user interface, a display of information associated with the particular action.

13. The system of claim 12, wherein determining that the one or more computing devices are located within the specified distance of the location associated with the service system comprises:
determining the geographic location of the service system;
determining a geographic location of each of the one or more user computing devices, wherein the location of each of the one or more user computing devices is determined based on one or more of global positioning system (“GPS”) information associated with the respective user computing device or based on an indication of a user computing device check-in to the service system or to a location within a predefined proximity of the service system; and
determining that the geographic location of each of the one or more user computing devices is within the specified distance of the location associated with the service system.

14. The system of claim 12, wherein determining the one or more actions to be taken by the service system with regard to at least one of the one or more respective users or the group of users of the one or more respective users comprises:
identifying a plurality of actions for achieving at least one of the one or more goals; and
determining the one or more recommended actions from the plurality of actions, wherein the one or more actions are determined based on the user information.

15. The system of claim 12, further comprising providing the service system with means for performing one or more of the recommended actions, wherein the one or more recommended actions are performed by communicating with one or more of the users at the respective user computing device of the user.

16. The system of claim 12, further comprising:
receiving a request to select a group of users of the one or more users based on one or more criteria;
determining one or more of the one or more users that satisfy the one or more criteria; and
identifying the one or more of the one or more users as the group.

17. A computer program product to provide in-store graphical user interfaces comprising customized controls associated with specified actions for particular users, comprising:
a non-transitory, computer-readable medium comprising computer executable program instructions stored therein, which when executed by a computer cause the computer to:
receive location information of a user computing device associated with a user;
determine, based on the received location information of the user computing device, that a location of the user computing device is within a specified distance of a location associated with a service system;
in response to determining that the location of the user computing device is within the specified distance of the location associated with the service system, retrieve user information regarding the user associated with the user computing device that is within the specified distance of the location associated with the service system, the user information comprising one or more of user characteristics and user activity information;
determining one or more goals associated with the service system;
identifying a plurality of actions based on a historical correlation between the plurality of actions and the one or more goals;
determining one or more recommended actions from the plurality of actions based on the user information and the one or more goals, the each of the one or more recommended actions corresponding to actions to be taken by the service system towards the user;
provide instructions to a computing device associated with the service system at the location of the service system to render, via a graphical user interface, a presentation of all or part of the user information while the user computing device is located within the specified distance of the location associated with the service system, the presentation including a control for displaying by the computing device associated with the service system and corresponding to a particular action of the one or more recommended actions together with the user information, selection of the control initiating the particular action towards the user associated with the user computing device that is within the specified distance of the location associated with the service system;
receive, from the computing device associated with the service system, an input indicating a selection of the control corresponding to the particular action; and
in response to receiving the input indicating the selection of the control, provide instructions to the computing device associated with the service system to update the graphical user interface to render, via the updated graphical user interface, a display of information associated with the particular action.

18. The computer program product of claim 17, wherein the non-transitory, computer-readable medium further comprises computer executable program instructions stored therein, which when executed by a computer cause the computer to:
receive a request to perform an action with respect to a group of the one or more users, the group of users being defined by a set of user characteristics determined from the user information;
identify one or more of the one or more users having the set of user characteristics; and
perform the action with respect to the one or more user computing devices associated with the one or more of the one or more identified users.

19. The computer program product of claim 17, wherein the location information comprises global positioning system (“GPS”) information of the user computing device.

20. The computer program product of claim 17, wherein the location information comprises data indicating a check-in of the user to the location associated with the service system or to a location within a threshold distance from the location associated with the service system.
